(19) United States
(12) Patent Application Publication
(10) Pub. No.: US 2001/0044785 A1
(43) Pub. Date: Nov. 22, 2001

(54) Method and system for private shipping to anonymous users of a computer network

(76) Inventors: Salvatore J. Stolfo, Ridgewood, NJ (US); Jonathan M. Smith, Princeton, NJ (US); Jeffrey D. Chung, Cupertino, CA (US)

Correspondence Address: PENNIE AND EDMONDS, 1155 AVENUE OF THE AMERICAS, NEW YORK, NY, 100362711

(21) Appl. No.: 09/754,897

(22) Filed: Jan. 5, 2001

Related U.S. Application Data
(60) Provisional application No. 60/174,638, filed on Jan. 5, 2000.

(51) Int. Cl. G06F 17/60

(52) U.S. Cl. 705/74

(57) ABSTRACT

A method and system for private shipping to anonymous users purchasing goods on a computer or communications network linking users with merchant web-sites for electronic commerce. A user is issued a proxy identity and the user's mailing address is received and encrypted. The proxy identity and encrypted mailing address are transmitted to a merchant, and decryption information is provided to a shipper. Upon receipt of the encrypted shipping address from the merchant, the shipper can use the decryption information to decrypt the address and generate a package label bearing the true shipping address of the user so that the merchant is prevented from electronically capturing the true identity of the user. The present invention provides for anonymity of a user when browsing and shopping, and integrates easily and simply with existing online infrastructures of banks or credit card issuers, and delivery companies.

### CROSS REFERENCE TO RELATED APPLICATIONS

This applications claims priority to U.S. Provisional Patent Application Ser. No. 60/174,638, entitled “Method and System for Private Shipping to Anonymous Users of a Computer Network”, filed Jan. 5, 2000.

### FIELD OF THE INVENTION

The present invention relates generally to networks and, more particularly, to a method and system that allows users to securely order and receive packages from merchants, without revealing their true identities to those merchants or any other network users, and without compromising their financial information.

### BACKGROUND OF THE INVENTION

As used herein, the term computer includes any device or machine capable of accepting data, applying prescribed processes to the data, and supplying the results of the processes. By way of example, but not limitation, the term “computer” includes mainframe computers, servers, personal computers, laptops, personal digital assistants, portable phones, cell phones, and calculators. The term “communications network” is also meant in a broad sense, and may include any suitable technology for information transmission, including electrical, electromagnetic and optical technologies. Such a communications network may link computers, e.g., a LAN or WAN. Although the inventions is described with particular reference to an open network, such as the Internet, it may also be used in other networks, internets and intranets.

The Internet continues to increase in importance as a place for business, offering a wide variety of information and services to potential customers. However, as an open network, the Internet provides opportunities to legally and illegally collect and use vast amounts of information which people consider both private and personal, and increasing concerns about privacy, fraud and security online could inhibit the continued growth of business-to-consumer “electronic commerce.”

Currently, shopping, browsing and other information-sharing activities on the Internet expose users to unwanted collection of their private and personal information, from which their identities, activities, behaviors and preferences can be ascertained. For example, without a user's permission, web marketers and merchants often gather “click data” that details every web-site a user visits with his or her browser. Underlying communications protocols and systems may provide additional private and/or personal information. In addition, users are often asked for, and provide, personal information about themselves in order to become a “member” of a particular web-site. This data is then used to create demographic profiles linked with the user's identity, including their name, postal address and e-rnail address, gender, age, and other personal information. This information is routinely bought and sold among parties who link and merge the information with other transaction data from other sources (i.e., “data mining”) offered for sale by third parties and vendors to create a sophisticated and detailed behavior profile of users, in order to target those users for advertising. This unwarranted level of intrusion into the private information of a user, often unknown to the user, is perceived as a fundamental threat to personal freedoms, creating an outcry among a number of privacy groups and a potential impediment to the growth of e-commerce. U.S. patent application Ser. No. 09/360,812, to one of the present inventors, which discusses these privacy concerns and discloses a system and method for anonymous Internet transactions, is hereby incorporated by reference.

Today commerce is typically conducted using credit card accounts issued by banks or credit card issuers, and delivery of physical goods is provided by shipping or delivery companies. The technical infrastructure and systems in use have been designed, developed and deployed over many years, certainly pre-dating the existence of the new technical infrastructure of the Internet and the World-Wide-Web. Furthermore, the existing transaction and delivery infrastructures involve complicated labor rules that manage worker procedures in order to optimize the process of performing many millions of transactions each day to reduce costs and maintain transaction speeds and throughputs (for very large volumes) and minimize delivery time (for guaranteed time limits of delivery, e.g., overnight delivery) for millions of packages each day. In order to provide private transactions and private shipping features on the Internet or Web, it is the goal of the present invention to integrate with the existing technical infrastructure of banks or credit card issuers and shipping or delivery companies in an easy and scalable fashion.

Credit card transactions are performed by customers at point of sale terminals (e.g., retail outlets), that are electronically attached to “acquirer” systems that route transaction information over private networks (e.g., the MASTERCARD® network) to banks or credit card issuers for authorization of the transaction. These communication networks are “private” utilizing systems, employing protocols that are different from the infrastructure of the Internet and World-Wide-Web. Integrating these older private communication networks with the Internet is a difficult and challenging task. It is a goal of the present invention to provide an easy means of integrating with bank or credit card issuer's existing authorization systems for private shopping and anonymous transacting.

It is a further goal of the invention that this integration will not change existing labor work rules and procedures. For example, in the case of delivery of physical goods, a merchant will typically print a label with the address of the recipient when the order is shipped. The physical, printed label is used by delivery company employees to route and physically move the labeled packaged through a complicated delivery system until it reaches by hand delivery its final destination. The physical, printed label is the most important information available to the delivery employee, and any change to the process will slow down delivery time. For example, for private shipping, re-labeling a package in order to redirect it to maintain customer anonymity (see, e.g. U.S. patent application Ser. No. 09/360,812) will cause serious delay and costly new technical systems needed to change a proxy address to a real shipping address. It is therefore another goal of the present invention to print a single label on a package that maintains the privacy of the customer and prevents the merchant from gaining easy access to the true identity of the recipient.

In a system with end-to-end privacy protection for online surfing and shopping, several important problems exist in integrating with existing online systems of large corporations, including banks or credit card issuers, and delivery companies. The size and scale of the markets each of these respective industries serve is so large that scaling online systems available over the Internet is extremely difficult. Most transactions are now performed using credit card accounts, each identified by a fixed length string of numbers that is inherently finite and limited in range. In the private surfing and shopping system disclosed in U.S. patent application Ser. No. 09/360,812, several issues have been noted:

(a) Will the banks or credit card issuers be able to do an online preauthorization in a very short time frame before the merchant web form is submitted to the merchant? The answer is apparently YES, but not without great expense to maintain the transaction throughputs demanded by market conditions.

(b) Will the banks or credit card issuers be able to generate multiple credit card numbers linked to a specific single credit card account? Each of these linked credit card numbers would be issued under a pseudonym for private shopping. The answer is apparently NO for the MASTERCARD®/VISA®issuers, but likely a definite YES for AMERICAN EXPRESS®.

(c) Will the banks or credit card issuers be able to assign a pool of card numbers used by a large collection of its customers? Here, an anonymous user would be granted permission to use one of these pooled numbers for a specific transaction to provide anonymity of their own identity and financial information. The answer is apparently NO.

d) Can the total amount of a purchase be extracted from a web page displayed in the customer's browser with high accuracy. Possible, but now probably not necessary.

The present invention dramatically simplifies the process under the constraints naturally imposed by the negative answers to (a)-(d).

### SUMMARY OF THE INVENTION

In a preferred embodiment, the present invention is a method for providing private shipping of items to anonymous users purchasing goods on a computer-based communications network comprising the steps of: providing a proxy identity to a user; receiving a shipping address for the user; partially encrypting the user's shipping address; transmitting the proxy identity and encrypted shipping address to a merchant; and providing decryption information to a shipper; whereby upon receipt of the encrypted shipping address from the merchant, the shipper can use the decryption information to decrypt the address and generate a package label bearing the true shipping address of the user so that the merchant is prevented from electronically capturing the true identity of the user. The proxy identity may comprise a proxy name and a proxy credit card account, and a new and different proxy name may be generated for the user for each shopping transaction or session. The shipping address may be encrypted so that the numerical information required for authorization under the Address Verification System is preserved. The communications network may be the Internet, and the user's proxy identity may be stored in a digital wallet on a user computer.

The step of issuing a proxy identity may include issuing a physical integrated circuit card to the user, and the proxy identity may be authenticated by reading the integrated circuit card via a card reader.

In a preferred embodiment, the encrypted shipping address contains sufficient information to allow the merchant to calculate an appropriate transaction tax, i.e., state sales tax. In still other embodiments, the method may further comprise maintaining a secure database of user transaction information, and providing access to the database to a shipper to resolve a shipping problem. The transaction information stored in the secure database may include instructions for returning items that are undeliverable.

The user's encrypted shipping address may contain an identifier that may be used as an electronic mail address to contact the user. The present invention may further comprise the step of generating a unique shopping session identification number, and the encrypted shipping address may be a function of the shopping session identification number. In still another embodiment, the encrypted shipping address is a function of time.

In another embodiment, a user selects a privacy level for a shipment, and a corresponding encryption algorithm for the user's shipping address is applied based upon the selected privacy level.

In still another embodiment, the present invention is a system for providing private shipping of items to users purchasing goods on a computer-based communications network comprising: a secure server computer including a processor configured to generate a proxy identity for a user, receive a shipping address for the user, and partially encrypt the user's shipping address; a database configured to store user identity information and transaction data; and a communications link for transmitting the proxy identity and partially encrypted shipping address to a merchant; so that the merchant is prevented from electronically capturing the true identity of the user. The processor may be configured to generate a unique shopping session identification number, and the user's encrypted shipping address may be a function of the shopping session identification number. The user's encrypted shipping address may also be a function of time.

### BRIEF DESCRIPTION OF THE DRAWINGS

The present invention will be understood and appreciated more fully from the following detailed description, taken in conjunction with the drawings in which:

FIG. 1 is a block diagram illustrating a system of the present invention; and

FIG. 2 is a flowchart illustrating the steps in a preferred embodiment of the method of the present invention.

### DETAILED DESCRIPTION OF THE PREFERRED EMBODIMENTS

Prior art shipping and delivery systems for physical goods are entirely dependent upon the printed address label. Typically, delivery companies provide merchants software for printing these labels. This software receives electronic information concerning the recipients' identity and shipping address from merchant order entry systems, and prints address information on paper labels that are then affixed to packages for delivery.

In U.S. patent application Ser. No. 09/360,812, a means of private shipping is described that involves a “secured address mapper” database (SAM). Relabeling of packages is performed by: a) first reading proxy identity information printed on a label and b) retrieving the true address information from the SAM and replacing the proxy identity with the real identity on the package. This seemingly easy technical process causes additional costs in modifying existing delivery systems and slows down the delivery processes for millions of packages.

In the present invention, a true address label is generated at the point of origination (when it gets affixed to the package), but in such a way that the information about the true identity of the recipient is not revealed to the merchant. This might be done so that the real address is available only on the paper label that is affixed to the package. As a result, if the merchant wanted to obtain a record of the address, he would have to have staff sitting at terminals and typing or scanning in the information when the delivery company software generates the paper label. If the identity information is prevented from being easily electronically replicated, but available only via physical means, (e.g., human reading and typing) that might be a sufficient costly impediment, along with other contractual constraints, to prevent merchants from automatically learning the true identity and address of anonymous shoppers, making this the safest and easiest way to integrate with existing shipping systems.

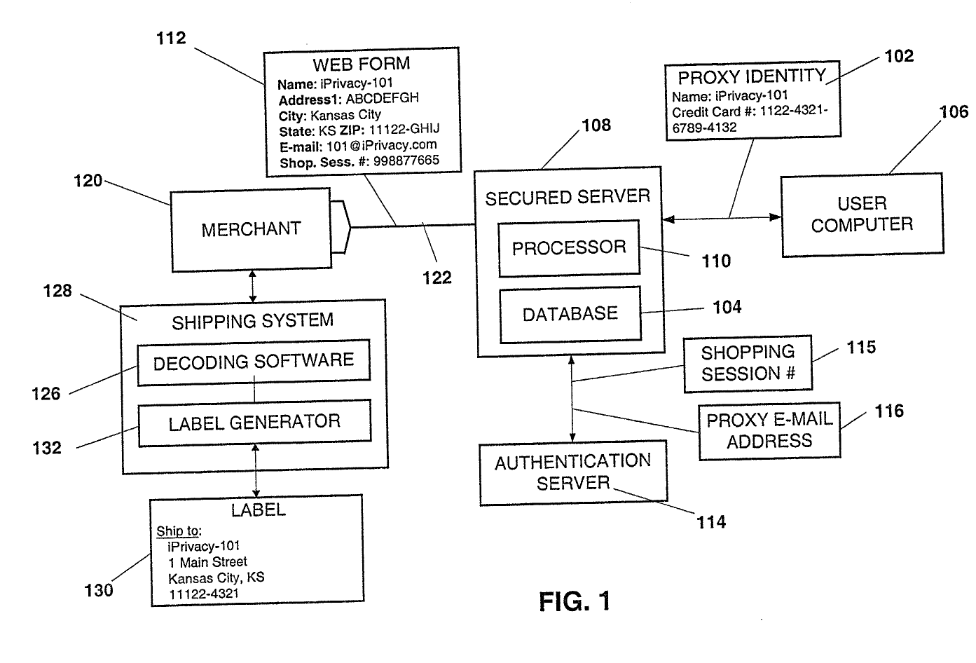

Reference is now made to FIG. 1 which is a block diagram illustrating the operation and components of a system of the present invention. To ensure that a customer's real name is not disclosed, a customer obtains from a bank or credit card issuer a proxy identity, with, minimally, a proxy credit card account and a proxy name. This information is loaded in a database 104 and accessible by the customer's client computer 106. Database 104 may be available on a server computer 108 and/or on the client computer 106. The proxy name may be assigned by a bank or credit card issuer, or it may be generated by processor 110 automatically as described below. The proxy identity may be stored in a digital wallet, which is software that works like a physical wallet during electronic commerce transactions. A digital wallet can hold a user's payment information, a digital certificate to identify the user, and shipping information to speed transactions, and may be resident at client computer 106 and/or on server computer 108.

The customer browses a merchant web site which provides a web form 112 to be filled out by the customer with order information and identity information. The customer selects a proxy identity 102 for submission to merchant web form 112.

The customer notifies server 108 by some means (e.g., by clicking a button or icon) that a private transaction utilizing proxy identity 102 is about to occur. Proxy identity 102 is authenticated and/or certified to be sure that the identity is valid. Server computer 108 contacts an Authentication Server 114, that is maintained with current information about customer proxy identities that are available for online purchasing. Server 108 sends the proxy identity information to Authentication Server 114, which either responds with an affirmative message (meaning the proxy identity is authentic and active) or denies the proxy identity. In the latter case, the customer is informed that the transaction cannot complete, and the session is ended. Alternatively, the authentication and/or certification of the proxy identity is performed at the client device (e.g., PC, handheld, etc.) using, for example, PIN's, passwords or other common means.

If Authentication Server 114 approves the transaction, server 108 generates a unique shopping session number, #F, 115, and a proxy e-mail identity 116 (e.g., 101 @iprivacy.com), and stores the customer's real e-mail address in a Secured E-Mail Address Mapper Database (SEAM) 104. Server 108 then sends a message to client computer 106 that the transaction can proceed, and client computer 106 assembles all relevant proxy information, including the proxy name (either bank assigned or generated from the shopping session number, e.g., iPrivacyCustomer#f), new shopping session number, #F, 115, proxy e-mail address 116, and a proxy shipping address, and enters it into a merchant web form 112. This information is then transmitted to a merchant 120 via communications links 122. The proxy shipping address displayed in merchant web form 112 may be formed by including e-mail address 116 (or a portion thereof) in the name field, an encrypted Street Address (e.g., a string of alphanumerics that may be decrypted into a real street address, e.g., ABCDEFGH), an encrypted Apartment Number (if applicable), but may include the real city, state and the first five digits of the zip code. The “+4” digits of the “ZIP+4”, if provided, are also encrypted.

Merchant 120 submits the customer's proxy financial information to a credit card authorization entity, which either authorizes or denies the transaction. If the transaction is denied, merchant web sites perform their typical functions and inform the customer that the transaction has failed. Otherwise, the transaction proceeds.

MAerchant 120 then directs software 126 at shipping system 128 to generate a label 130 for the physical good(s) ordered by the customer. The shipping label printing software 126 receives the proxy shipping information, and decrypts the street address, apartment number and “+4” zip code information, and a label generator 132 prints physical label 130. Software 126 is constructed so that the decrypted information cannot be captured electronically but rather generates printer commands to generate printed characters with the real address information. The proxy name, e.g., iPrivacy-101, is not decoded into a real name, and is also printed on the label.

The delivery company takes receipt of the package for delivery, and carries and delivers the package to the recipient's address now printed on the label. A confirmation of the delivery is noted by the delivery company, and sent to the private shopping server signaling the completion and termination of the transaction. The delivery confirmation code may be stored for future reference in database 104.

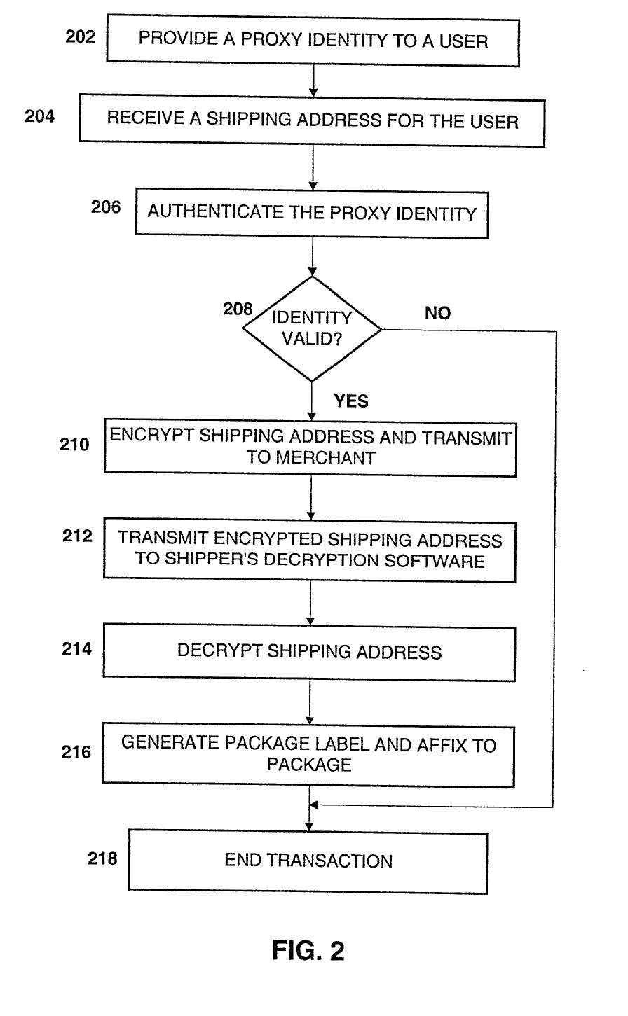

Reference is now made to FIG. 2, which is a schematic block diagram illustrating the steps in a preferred embodiment of the method of the present invention. In step 202, a user wishing to purchase a good from an online merchant is provided with a proxy identity, which may consist of a proxy name and a credit card account/number dedicated solely to online purchases. The user may be provided with a new and different proxy name for each online shopping session the user undertakes. The user provides his or her mailing address to a secure server in step 204. Prior to forwarding the user information to the merchant web site, the server authenticates the user's proxy identity (i.e., verifying the credit card information) in step 206. Alternatively, the server may generate a proxy identity (e.g., proxy name and e-mail address) for the user at the time of the transaction. In step 208, if the user's proxy identity is invalid, the transaction is terminated in step 218. If, however, the proxy identity is valid (i.e., the user is authorized to use a valid credit card account), the user's mailing address is encrypted and transmitted to the merchant web site, along with the proxy identity, in step 210. In an alternate embodiment, the user's credit card information is held locally at the user computer (e.g., client) and is not verified by the server. It should be pointed out that the entire address could be encrypted, or just the house number and street portion of the address field. In step 212, the user's encrypted shipping address is transmitted to the shipper. In step 214, decryption information, such as computer software, supplied to the shipper by the trusted entity maintaining secure server 108 decrypts the Nailing address, and in step 216, a package label with the user's true address generated. It should be emphasized that only the user's true address would be revealed on the package label, not the user's true name or e-mail address. It should also be understood, as one of ordinary skill in the art will recognize, that a variety of cryptographic algorithms can be used in implementing the present invention. For purposes of illustration and not limitation, one example of such a cryptography scheme is public key/private key encryption. In such an embodiment, encryption keys can be periodically rotated for additional security.

This process is described by way of an example. Given the true identity of a customer who wishes to remain anonymous to web merchants:

Joe Smith

1000 Main Avenue

Des Moines, Iowa 77755

smith @myisp.com

the customer would send to the merchant, via the web merchant's web form at the time of purchase, and through the order entry system, the following proxy identity:

iPrivacy 123456789012

ABCDEGFGHJOILKJILMSH

Des Moines, Iowa 77755

123456789012@iprivacy.com

Notice the Name field is proxied by a shopping session number, 115. Alternatively, the printed label may replace the proxy name (e.g., iPrivacy 123456789012) with a proxy e-mail address or some other identifying information. The city, state and zip are transmitted, since the density of the population in a typical zip code is large enough to create anonymity, and the ADDRESS 1 field, typically holding number and street address has instead a CODE that encrypts or encodes the true address. When this proxy address is sent through the merchant's order processing system, ultimately that system sends an electronic message to the shipping system that generates the labels placed on packages. The shipping system software is typically supplied by delivery companies. When that shipping system receives this proxy address, it would use decryption information, such as a computer software program provided by the trusted entity maintaining secure server 108, to decrypt the ADDRESS 1 field (i.e., house number and street) and generate a paper label placed on the package that appears:

iPrivacy 123456789012

1000 Main Avenue

Des Moines, Iowa 77755

123456789012@iprivacy.com

Thus, the true number and street address are recovered and printed on the label, but not the customer's true name or true e-mail address. Those two key pieces are still proxied. The only way a merchant can use this label-printed information is either a) scanning it, or b) having staff type it in, then go to the costly process of finding who the customer may be on the basis of his address.

The essence of this process is that the banks or credit card issuers issue credit card accounts to their customers, which are used only for private online purchases. Users simply shop by filling out web forms with their proxy identity and proxy credit card. The transaction is authorized in the normal course of processing a credit card purchase. However, an “identity pre-authentication” is performed to ensure that the credit card account is used only with bank issued software and/or that the proxy identity and proxy credit card account have not been “turned off” by the bank. That authentication process can be implemented readily using standard “digital certificate” technology. Optionally, the identity pre-authentication step discussed above is performed using physical integrated circuit chip card (“IC card”) technology. These IC cards are physically delivered to customers and used with a card reader attached to a user's personal computer or hand-held device to further certify and authenticate the use of the credit card information. By delivering physical IC cards to consumers, banks may therefore deliver certificates or serial numbers more securely.

A proxy e-mail identity, e.g. SS#F@ipnvacy.com, where “SS” stands for Shopping Session and “#F” is the unique shopping session number generated by the server, is generated for the customer each time he shops. If he wishes to have his behavior captured by a particular merchant, he can be assigned a proxy e-mail address, which is stored in a secured e-mail address mapper (SEAM) database, for periods of time longer than the lifetime of a transaction. The private credit card account can be used by a merchant to maintain a transaction history for a customer, but the customer will still remain anonymous. The merchant, however, cannot contact that customer via e-mail if/when the forwarding function associated with the proxy e-mail address is turned off. The proxy identity (e-mail, name, address, etc.) can be varied each time the private credit card account is used. Alternatively, a user may choose to reuse a prior proxy e-mail address previously provided to him. This proxy e-mail address lives as long as the shopping session/transaction lives, and is flushed from the system once the shipping company's confirmation code (H) is received. The shopping session number may be reused under certain circumstances such as subscriptions and/or installments. The reuse of the shopping session number is at the discretion of the authorizing bank. It is this e-mail address that is provided to merchants and the Secured E-mail Address Mapper (SEAM). It should also be understood that a web-based e-mail system could be implemented so that users would not have to disclose their true e-mail addresses at all. In this embodiment, a user could log into the web-based e-mail system and read the e-mail messages sent to his or her proxy e-mail address.

If the real address of each recipient includes an email address, the secure server 108 creates an email proxy to facilitate the communication between the shipping company and the recipient (e.g., providing a tracking number, etc.). If an email is not available, the label may contain a pointer to a web server with the real information of the recipient. This web server provides access to a limited view of the secured transaction database 104 (STD). (Alternatively, the shipping/delivery company may be given access to the STD). The delivery person can follow the link that is printed on the label and access the contact information. Instead of a URL, the label may contain an email address that provides similar functions, e.g., an e-mail to SS#F-i@iprivacy.com returns the contact information of the recipient, as long as it originates from authorized personnel.

Customers who shop at a web site must first open their digital wallet and click on “private” in their wallets to initiate an online pre-authentication of their proxy identity by server 108. Banks and credit card issuers only need to provide a steady stream of information about proxy credit card accounts that have been deactivated or deleted. The integration task with the digital wallet is to provide the means of doing the preauthentication when the user chooses the proxy identity. That step requires the server to generate a new shopping session number 115 after authentication occurs, and create a proxy e-mail address 116 at the client in the digital wallet.

Alternatively, printed label 130 could include an identifier that serves as a proxy name for the customer and can be easily converted to an e-mail address. Consider the following label:

iPrivacy 123456789012

1000 Main Avenue

Des Moines, Iowa 77755

The name field (e.g., iPrivacy123456789012) in the label above may be converted to a simple e-mail address as follows: 123456789012@iprivacv.com.

It is also desirable to encrypt a user's address, e.g., 1 MAIN STREET, so that the code is a) hard to break b) decoded fast and c) there are several different versions of the encryption that all decode to 1 MAIN STREET so that a single encoding can't be used to time correlate the user's buying behavior. The system should not present the same encryption string for the user's real address each time he/she buys at a web-site because the common string can be used to time correlate the user's transactions and/or once one address is breached, all records containing that same address encryption are breached.

For most web merchants, there is enough room in the address field of the web merchant web form to store the encrypted address and some other characters. This additional space in the web form can be used to randomly inject an error or false character into the real address, so that the resultant encrypted address will vary each time. That random error should be trivial to find and delete when the string is decrypted. For example, let “f1” be an encryption function that behaves as a non-linear function that enccrypts an input string and is hard to invert without knowing a secret decryption function, f2. Thus, f1(x)=y, and f2(y)=x. By defining f1 to be a non-linear function then a slight perturbation to the input causes the function to generate a value that varies widely.

Let f1(“1 MAIN STREET”)=code 1 (e.g., 1A2B3C4D5E6F7G8H9I)

Now, if another character is injected into the string “1 MAIN STREET”, the resultant encrypted string should be very different from the string produced otherwise because f1 is non-linear. Thus, f1(“1% MAIN STREET”)=code2 (e.g., X9Y8W7R6U5D4H3). Here the character “%” is injected into the string in the second character position. Notice that code1 is very different from code2.

For decryption purposes, a deccryption function, f2, applies a mathematical function inverting the encryption function f1, and deletes any characters that were injected by the encryption function f1. Thus, f2(code1)=f2(code2)=“1 MAIN STREET”. Thus, the “%” character which was injected to create code2 is deleted by f2 to produce the true address, “1 MAIN STREET”.

The “%” character was chosen in this example because it is a predefined printable character that does not typically appear in an address field. This, and other similar characters, e.g., “.!@♯#$%Λ&*( )_+,” are injected in a controlled fashion into the client's real address field. These atypical characters would therefore look like “random” errors in an address field, but cause “1 MAIN STREET” to be encrypted with a widely varying set of encryption strings.

When an encrypted address is input into the decryption function by the printer software, the atypical characters are deleted from the string to produce the correct real address. Injecting “random errors” in a controlled fashion as described above will generate a finite number of encryptions per real address, but each will be widely variable, and hard to decrypt into the real address. Advantageously, the wide variety of encrypted strings produced for a single real address will prevent time correlation of user's behavior using a single string that otherwise would be provided for his real address.

There are several advantages to the present invention:

1. The integration task with the banks is greatly simplified. The integration entails little more than storing bank-generated proxy identities and new card accounts in a database accessible for authentication purposes. This data base application only needs updates from the bank when identities come and go.

2. Integration with current credit card transaction systems is trivial. What is submitted to the web form and the credit card acquirer is exactly what the card issuer/acquirer expects to see, the private identity and card number they have issued to a customer. The banks do not need to build any special integration or matching software to link multiple accounts.

3. A great deal of intelligence at the client to read and extract information from web forms is unnecessary. The chosen digital wallet technology simply fills forms with the proxy identity. Financial authorization (e.g., credit limits, fraud detection) are all performed as standard practice today. The wallet technology includes password protections, and the pre-authentication step helps ensure fraud reduction.

4. Integration with the digital wallet/forn filler is greatly simplified. The integration task entails contacting the server when the wallet is opened and a private identity is selected to: a) authenticate the user's proxy identity and b) if authenticated, generate a new shopping session number, create a proxy e-mail account on the SEAM (Secured E-mail Address Mapper) server (with forward to the user's real e-mail uploaded from the wallet), and download to the client wallet the new proxy e-mail identity to be used in filling the web forms.

5. Authentication task is greatly simplified. Standard certificate schemes can be used.

6. Integration with shipping systems is trivial. By printing physical labels with the real address of the customer, there is no need for delivery company systems to be electronically integrated with a SEAM database.

7. Tax computations are simple. Since the actual city and state where delivery is to be made are revealed to the merchant during the transaction, merchants can easily apply the appropriate tax rate for purchases. This is an important issue for lawmakers who are debating schemes for taxing e-commerce transactions.

An additional problem that some merchants may encounter is that they may not have shipping contracts with a shipping company that has implemented the decoding software needed for private shipping. However, even if a merchant has no relationship with a shipping company that employs the necessary decoding software, private shipping can still be provided by shipping to a depot. For example, at some web-sites it may not be possible to ship via Federal Express™ if United Parcel Service (UPS) has an exclusive deal with the merchant. However, shipping via the U.S. Postal Service (USPS) is an option at all web-sites as a default. (Even if all shipping companies are available at a web-site, users generally cannot choose which one to use for shipping their merchandise.) Therefore, a web-site may have an exclusive shipping contract with UPS, even though UPS does not provide private shipping. If a user transacting on this web-site wishes to ship privately, there would be no way to generate the encrypted proxy address label discussed above. The solution to this problem is to use the U.S. Postal Service (USPS) as a default private shipping carrier.

For example, if the true shipping address is:

John Smith

1 Main Street

Kansas City, Mo. 11122

The private shipping label, with the USPS as the default private shipping carrier would be:

iPrivacy-101

ABCDEFGHIJ

P.O. Box 99999

Kansas City, Mo. 11122where iPrivacy-101 is the proxied name of the user, ABCDEFGHIJ is the encrypted street address, and P.O. Box. 99999 is a standard caller service post office box, owned by an entity providing the private transaction service and operated by the USPS at each and every post office nationwide. The number assigned to the post office box in a particular area may be a function of the area's actual zip code.

Now, if Federal Express supports private shipping and Federal Express decoding software is enabled at the web-merchant, when this label information is sent to the Federal Express software, it will decode:

iPrivacy-101

1 Main Street

Kansas City, Mo. 11122

Notice in the decoded label above that the post office box has been removed and the true address has been decoded for shipping to the user's home.

In the alternative, if Federal Express decoding software is not enabled at the web-merchant, then the label generated will include the post office box number (P.O.B. 999999) which a) forces the USPS to ship from the web-merchant (because Federal Express and UPS cannot ship to post office boxes) and b) the package is held at the post office in zip code 11122 for customer pick up. In this scenario, decoding software at the user's post office can produce the user's home delivery address so that the package may be delivered to the user's home by the USPS, or, alternatively, a postcard is printed by the decoding software and carried home to the user.

In addition to the problem discussed above, as a security measure, some web-sites require that the shipping address for an order be the same as the billing address associated with the credit card used for payment. Thus, at these sites, items may only be shipped to the billing address associated with the credit card. In such cases, if a user's shipping address is encrypted as above for privacy reasons, the shipping address will not match the user's billing address, and the user will not be able to shop and ship privately.

This problem is solved as follows. As known in the art, credit card payments require an authorization from the credit card issuer (e.g., bank) that includes a check of the billing address to ensure that it conforms to the address on file for the customer. This check requires sending the credit card number, expiration date, and a portion of the billing address to the credit card issuer for verification and authorization of the transaction.

The user's billing address is checked via a process known in the credit card industry as Address Verification System (AVS). According to this process, a portion of the billing address is extracted from the user specified billing address by a well-known algorithm: the first five leading numerals in the address field, excluding dashes, slashes, and periods, are extracted before a blank space is reached. The zip code is then added to this string to produce the “AVS string” for AVS processing. For example, if the billing address specified is:

1 Main Street

Kansas City, Mo. 11122

The AVS string produced for AVS processing is “1, 11122”. If the billing address is

102-23 2^{nd} Street Kansas City, Mo. 11122

The AVS string produced for AVS processing is “10223,11122”.

Therefore, in order to ensure that the encrypted shipping address will pass the AVS process, and the private shipment will be processed and received by the user, a user's shipping address will be encrypted as follows. Given a user's true name and address:

John Smith

102-23 2^{nd} Street

Kansas City, Mo. 11122

The private shipping information will be:

iPrivacy-101

10223 ABCDEFGH

P.O.B. 999999

Kansas City, Mo. 11122

Combining all of the steps described above, this proxy address:

1) Proxies the name of the user (iPrivacy-101)

2) Proxies the street address field, but includes the numerical information

necessary (10223) to satisfy the AVS process for billing address verification.

Note that the portion of the street address reading “ABCDEFGH” may be decoded by private shipping software enabled at the web-site.

3) Provides a standard “caller service” post office box number (999999) to allow for private shipment to the post office box by the USPS if decoding software is not enabled at the web-site.

In one variation of this embodiment, the encrypted portion of the street address (“ABCDEFGH”) is not included in the address so that the intended point of delivery is the post office box.

There is, however, an additional problem created by the post office box pickup scenario. An unauthorized third party may intercept the communication between the user and the retailer and attempt to pick up the privately shipped package at the post office. The post office would, therefore, need to verify or authenticate the identity of the private user before releasing the package. To authenticate the user, the post office can ask for proof of address (via driver's license or some other document) in order to match the street number on the package label (e.g., 10223 in the example above) with the address on the identification document. In addition to a driver's license, several other types of documents can be used to verify a user's address for identification purposes such as a utility bill, passport, or any other document generally acceptable to the post office.

Address verification is the preferred mode of identification, but in alternate embodiments, other means of identification, such as a portion of the user's social security number, can be included as a prefix on the proxied address field, and the user could then display his or her social security card at the post office to authenticate himself or herself as the proper recipient of the package. For example, if the user's social security number is 123-45-6789, the label could be modified to read:

iPrivacy-101 10223 ABCDEFGH

P.O.B. 999999-123-45

Kansas City, Mo. 11122

As shown above, the first five digits of the user's social security number, e.g., “123-45”, have been added to the address field, appearing after the post office box number. These digits could also be printed on some other field of the label. The user would then show their social security card displaying their social security number, e.g., 123-45-6789, to verify their identity and pick up their package.

In another embodiment, a portion of the user's proxy credit card account number could be printed on the label as a means of verification. The server would then generate and send an e-mail message to the user's proxy e-mail address that includes the proxy shipping information and a portion of the user's proxy credit card number (e.g., the last four digits). The last four digits of the user's proxy credit card number would appear on the e-mail, and the user can print out the e-mail message and present it to the post office, together with the proxy credit card, to verify that the user is the legitimate owner of the package.

Alternatively, a secret code can be securely provided to both the user and the post office, and the user would need to match the secret code to the same code provided to the post office. This embodiment may require some alteration of substantive post office procedures because the post office would need to receive the secret code over a secure channel.

As described above, the invention provides for private shipping of goods as a single delivery. In the most general case, however, a transaction may involve multiple goods purchased across many retailers and delivered to multiple locations. The person purchasing goods on the Internet may be different from the person receiving the goods. The concepts discussed above can be used with separate deliveries to multiple addresses from a single web retailer. Again, the shopping session number, SS#F, will go to all shipping addresses (as in the case with a single delivery). However, to be able to distinguish among the various shipments, SS#F has two parts: one which is common across all shipments and is the same as the transaction number, and one that distinguishes each shipment. For example, SS#F-1, SS#F2, may be used for the first and second shipment in a series of shipments, respectively. Encoding and decoding addresses by the shipping system is performed as in the case of a single shipment. In this case, the user's digital wallet and the secured transaction server (STS) send a new encrypted label to the shipper software for every SS#F-i that is generated, i.e., for every real shipping address.

The invention processes transactions that span across multiple shops in a similar manner. Provided the STS can access the shipping software of all merchants, two scenarios are possible:

1) STS generates a single SS#F-i for each delivery address. In this case, different merchants get the same encrypted labels for each recipient. (This is easier to integrate in malls).

2) STS generates different SS#F-i for each delivery address for each recipient. Thus, the same recipient will have two distinct SS#F-i's with two different retailers. (The advantage is that it's easier to track when the transaction is complete: when the shipper sends i confirmation messages to STS).

In addition to the problems discusses above, delivery may fail for other reasons. For example, users who live in multiple unit buildings (e.g., apartment buildings) may neglect to input their suite number or apartment number in the address field on a web merchant form. Without such information on a shipping label, delivery companies are forced to rely on the user's name to effect delivery. In the present invention, the user's name does not appear on the shipping label, so the user must take special care to enter his or her apartment number or suite number. When inputting the shipping address information into the digital wallet, the software system can make sure the user enters his or her apartment number to reduce the chances that the apartment number is forgotten. Additional reminders at the time users enter the data should substantially reduce the problem. Another alternative is to display the address label as it would be printed via a pop up window each time the user makes a purchase and uses his wallet along with the proxy name as it will appear on the label placed on the parcel. That information can be held at the client PC as a reminder when the package arrives to help identify the recipient of the parcel. Alternatively, an e-mail containing the proxy name can be generated and sent to the user to serve as a proof of purchase and help identify the recipient of the parcel.

Another issue to consider is whom do customers call when they don't receive their parcel? The merchant from whom they purchased the parcel would be the logical entity to contact. The user may refer back to the transaction information stored on his behalf at the client and/or a transaction database located on a secure server. Part of the user experience may include notes or reminders about this issue with directions to the user to whom he should call in the case of failed deliveries.

Yet another issue to consider in private shipping is where does the delivery company send undeliverable or refused parcels? For example, a back-ordered item may arrive after the ordering party has moved. Under typical practice today, the delivery company obligation is completed when the parcel is physically delivered to a mailbox, or hand delivered to some person answering a door and taking receipt of the package.

To ameliorate this problem, the delivery company may return the package to the retailer. In such cases, the transaction is still active (not “retired”) until a final delivery confirmation is received from the delivery company and so the retailer would have available a means to contact the user to inforn them of the problem. Furthermore, because the proxy email address is available on the printed label, the delivery employee or letter carrier may send email to the anonymous customer informing them of the delivery problems with directions to the local post office or delivery depot center where the package may be retrieved.

While the present invention has been described with reference to the preferred embodiments, those skilled in the art will recognize that numerous variations and modifications may be made without departing from the scope of the present invention. Accordingly, it should be clearly understood that the embodiments of the invention described above are not intended as limitations on the scope of the invention, which is defined only by the following claims.

What is claimed is:

1. A method for providing private shipping of items to users purchasing goods on a computer-based communications network comprising the steps of:
providing a proxy identity to a user;
receiving a shipping address for the user;
partially encrypting the user's shipping address;
transmitting the proxy identity and encrypted shipping address to a merchant; and
providing decryption information to a shipper whereby upon receipt of the encrypted shipping address from the merchant, the shipper can use the decryption information to decrypt the address and generate a package label bearing the true shipping address of the user so that the merchant is prevented from electronically capturing the true identity of the user.

2. The method of claim 1, wherein the proxy identity comprises a proxy name and a proxy credit card account number.

3. The method of claim 2, wherein the step of issuing a proxy identity includes issuing a physical integrated circuit card to the user.

4. The method of claim 3, further comprising the step of authenticating the user's proxy identity.

5. The method of claim 4, wherein the step of authenticating the proxy identity includes reading the integrated circuit card via a card reader.

6. The method of claim 2 wherein a new proxy name is generated for each transaction by the user.

7. The method of claim 1 wherein the communications network is the Internet.

8. The method of claim 1 wherein the user's proxy identity is stored in a digital wallet.

9. The method of claim 1, wherein the encrypted shipping address contains sufficient information to allow the merchant to calculate an appropriate transaction tax.

10. The method of claim 1, further comprising:
maintaining a secure database of user transaction information; and
providing access to the database to a shipper to resolve a shipping problem.

11. The method of claim 10, wherein the transaction information includes instructions for returning undeliverable items.

12. The method of claim 1, wherein the user's encrypted shipping address contains an identifier that may be used as an electronic mail address to contact the user.

13. The method of claim 1, further comprising generating a unique shopping session identification number.

14. The method of claim 13, wherein the encrypted shipping address is a function of the shopping session identification number.

15. The method of claim 1, wherein the encrypted shipping address is a function of time.

16. The method of claim 1, wherein the encrypted shipping address includes an index number for cross-reference to a database of real shipping addresses.

17. The method of claim 1, further comprising randomly inserting at least one atypical textual character into the true shipping address before encrypting the shipping address.

18. The method of claim 1, further comprising:
receiving a privacy level selection from the user for a shipment; and
selecting an encryption algorithm for the user's shipping address based upon the selected privacy level.

19. A method for providing private shipping of items to users purchasing goods on a computer-based communications network comprising the steps of:
providing a proxy identity to a user;
receiving a shipping address for the user;
partially encrypting the user's shipping address;
appending a post office box number to the user's encrypted shipping address;
transmitting the proxy identity and encrypted shipping address to a merchant; whereby upon receipt of the encrypted shipping address from the merchant, the shipper can generate a package label bearing the partially encrypted mailing address of the user with the post office box number so that the merchant is prevented from electronically capturing the true identity of the user.

20. A system for providing private shipping of items to users purchasing goods on a computer-based communications network comprising:
a secure server computer including
a processor configured to generate a proxy identity for a user, receive a shipping address for the user, and partially encrypt the user's shipping address;
a database configured to store user identity information and transaction data; and
a communications link for transmitting the proxy identity and partially encrypted shipping address to a merchant; so that the merchant is prevented from electronically capturing the true identity of the user.

21. The system of claim 20, wherein the processor is further configured to generate a unique shopping session identification number.

22. The system of claim 21, wherein the user's encrypted shipping address is a function of the shopping session identification number.

23. The system of claim 20, wherein the user's encrypted shipping address is a function of time.

24. The system of claim 20, wherein the encrypted shipping address includes an index number for cross-reference to a database of real shipping addresses.

25. A method for providing private shipping of items to users purchasing goods on a computer-based communications network comprising the steps of:
providing a proxy identity to a user;
receiving a shipping address for the user;
partially encrypting the shipping address so that the numerical information required for authorization under the Address Verification System is preserved;
transmitting the proxy identity and encrypted shipping address to a merchant;
and
providing decryption information to a shipper whereby upon receipt of the user's proxy identity and Address Verification String from the merchant, a credit card issuer can authorize the purchase, and upon receipt of the encrypted shipping address from the merchant, the shipper can use the decryption information to decrypt the address and generate a package label bearing the true shipping address of the user so that the merchant is prevented from electronically capturing the true identity of the user.

26. The method of claim 25, wherein the proxy identity comprises a proxy name and a proxy credit card account number.

27. The method of claim 25, wherein the communications network is the Internet.
